(19) United States
(12) Patent Application Publication
(10) Pub. No.: US 2022/0121692 A1
(43) Pub. Date: Apr. 21, 2022

(54) METHOD, APPARATUS, DEVICE AND COMPUTER STORAGE MEDIUM FOR RETRIEVING GEOGRAPHIC POSITIONS

(71) Applicant: BAIDU ONLINE NETWORK TECHNOLOGY (BEIJING) CO., LTD., Beijing (CN)

(72) Inventors: Huang Jizhou, Beijing (CN); Haifeng Wang, Beijing (CN); Miao Fan, Beijing (CN)

(21) Appl. No.: 17/285,857

(22) PCT Filed: Nov. 25, 2020
(86) PCT No.: PCT/CN2020/131321

§ 371 Date: Apr. 15, 2021

(30) Foreign Application Priority Data
Apr. 24, 2020 (CN) 202010334224.1

(51) Int. Cl. G06F 16/29; G06N 3/04; G06F 16/28; G06K 9/62

(52) U.S. Cl. CPC G06F 16/29; G06K 9/6257; G06F 16/28; G06N 3/0454

(57) ABSTRACT

The present disclosure provides a method, apparatus, device and computer storage medium for retrieving geographic positions, which relates to the field of artificial intelligence. A specific implementation solution is: respectively determining a vector representation of each character in a query by using an international character vector representation dictionary; inputting the vector representations of respective characters in the query into a first neural network to obtain a vector representation of the query; determining a similarity respectively between the vector representation of the query and a vector representation of each geographic position in a map database; determining a retrieved geographic position according to respective similarities; wherein the vector representation of each geographic position is obtained by using the international character vector representation dictionary to determine vector representations of characters in descriptive texts of the geographic positions, and inputting the vector representations of the characters in the descriptive texts of the geographic positions into a second neural network; the international character vector representation dictionary is used to map characters of at least two languages to the same vector space. The present disclosure can better satisfy cross-language geographic position retrieval demands.

The present disclosure claims priority to the Chinese patent application No. 2020103342241 entitled “Method, Apparatus, Device and Computer Storage Medium for Retrieving Geographic positions” filed on the filing date Apr. 24, 2020, the entire disclosure of which is hereby incorporated by reference in its entirety.

### FIELD OF THE DISCLOSURE

The present disclosure relates to the technical field of computer application, and particularly to the technical field of artificial intelligence.

### BACKGROUND OF THE DISCLOSURE

Regarding map-like applications, geographic position retrieval is one of functions most frequently used by users. Either at the client end or webpage end, a user may input a query at a retrieval function entry in the form of a text or speech to retrieve geographic positions.

Conventional geographic position-retrieving methods mostly employ a manner of literally matching the query with the names of the geographic position for retrieval, and cannot well meet the needs of semantics-associated geographic position retrieval, even cross-language geographic position retrieval.

For example, when a Chinese user retrieves the Eiffel Tower located in Paris of France, he probably uses a Chinese query for retrieval. However, as internationalized map service, the Eiffel Tower is probably marked in a local language, namely, French language, or in internationally universal English language. Therefore, pure literal matching cannot duly meet the needs of cross-language retrieval.

### SUMMARY OF THE DISCLOSURE

In view of the foregoing discussions, the present disclosure provides a method, apparatus, device and computer storage medium for retrieving geographic positions, to better satisfy cross-language geographic position retrieval demands.

In a first aspect, the present disclosure provides a method for retrieving geographic positions, including:

respectively determining a vector representation of each character in a query input by a user using an international character vector representation dictionary;

inputting the vector representations of respective characters in the query into a first neural network obtained by pre-training, to obtain a vector representation of the query;

determining a similarity respectively between the vector representation of the query and a vector representation of each geographic position in a map database;

determining a retrieved geographic position according to respective similarities;

wherein the vector representation of each geographic position is obtained by using the international character vector representation dictionary to determine vector representations of characters in descriptive texts of the geographic positions, and inputting the vector representations of the characters in the descriptive texts of the geographic positions into a second neural network obtained by pre-training; the international character vector representation dictionary is used to map characters of at least two languages to the same vector space.

In a second aspect, the present disclosure provides an apparatus for retrieving geographic positions, including:

a first vector determining unit configured to respectively determine a vector representation of each character in a query input by a user using an international character vector representation dictionary, the international character vector representation dictionary being used to map characters of at least two languages to the same vector space;

a second vector determining unit configured to input vector representations of the characters in the query into a first neural network obtained by pre-training, to obtain a vector representation of the query;

a similarity determining unit configured to determine a similarity respectively between the vector representation of the query and a vector representation of each geographic position in a map database; wherein the vector representation of each geographic position is obtained by using the international character vector representation dictionary to determine vector representations of characters in descriptive texts of the geographic positions, and inputting the vector representations of the characters in the descriptive texts of the geographic positions into a second neural network obtained by pre-training;

a retrieval processing unit configured to determine a retrieved geographic position according to respective similarities.

In a third aspect, the present disclosure further provides an electronic device, including:

at least one processor; and

a memory communicatively connected with the at least one processor; wherein,

the memory stores instructions executable by the at least one processor, and the instructions are executed by the at least one processor to enable the at least one processor to execute the method according to the above first aspect.

In a further aspect, the present disclosure further provides a non-transitory computer-readable storage medium storing computer instructions therein, wherein the computer instructions are used to cause the computer to execute the method according to the above first aspect.

As can be seen from the above technical solutions, in the present disclosure, the international character vector representation dictionary is used to map characters of different languages to the same vector space, the vector representation of the query and the vector representations of geographic positions are respectively obtained based on the vector representations of the characters, thereby determining the retrieved geographic position further based on the vector representation of the query and the vector representations of the geographic positions. This manner can better satisfy cross-language geographic position retrieval demands.

Other effects of the above optional modes will be described below in conjunction with specific embodiments.

### BRIEF DESCRIPTION OF DRAWINGS

The figures are intended to facilitate understanding the solutions, not to limit the present disclosure. In the figures,

FIG. 1 illustrates an exemplary system architecture to which embodiments of the present disclosure may be applied;

FIG. 2 illustrates a schematic diagram of a computing framework of a similarity model according to embodiments of the present disclosure;

FIG. 3 illustrates a flow chart of a method for retrieving geographic positions according to Embodiment 1 of the present disclosure;

FIG. 4 illustrates a flow chart of a method for training a similarity model according to Embodiment 2 of the present disclosure;

FIG. 5 illustrates a schematic diagram showing the principles for training the similarity model according to Embodiment 2 of the present disclosure;

FIG. 6 illustrates a flow chart of a method for training a similarity model according to Embodiment 3 of the present disclosure;

FIG. 7 illustrates a schematic diagram of building a sematic graph according to Embodiment 3 of the present disclosure;

FIG. 8 illustrates schematic diagram showing the principles for training the similarity model according to Embodiment 3 of the present disclosure;

FIG. 9 illustrates a block diagram of an apparatus for retrieving geographic positions according to embodiments of the present disclosure;

FIG. 10 illustrates a block diagram of an electronic device for implementing embodiments of the present disclosure.

### DETAILED DESCRIPTION OF PREFERRED EMBODIMENTS

Exemplary embodiments of the present disclosure are described below with reference to the accompanying drawings, include various details of the embodiments of the present disclosure to facilitate understanding, and should be considered as being only exemplary. Therefore, those having ordinary skill in the art should recognize that various changes and modifications can be made to the embodiments described herein without departing from the scope and spirit of the application. Also, for the sake of clarity and conciseness, depictions of well-known functions and structures are omitted in the following description.

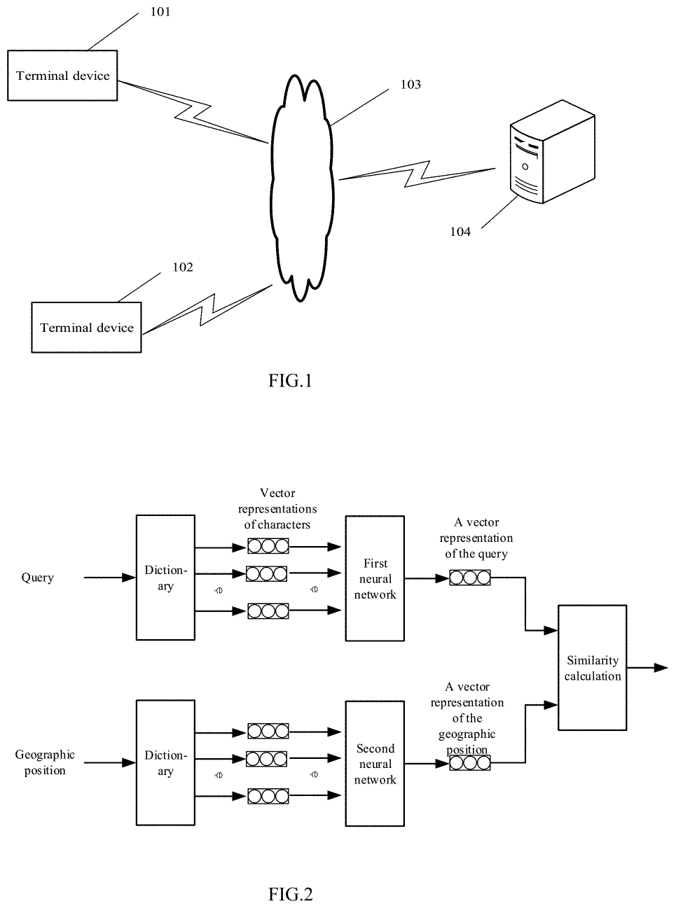

FIG. 1 illustrates an exemplary system architecture to which embodiments of the present disclosure may be applied. As shown in FIG. 1, the system architecture may comprise terminal devices 101 and 102, a network 103 and a server 104. The network 103 is used to provide a medium for a communication link between the terminal devices 101, 102 and the server 104. The network 103 may comprise various connection types such as wired link, a wireless communication link or an optical fiber cable.

The user may use the terminal devices 101 and 102 to interact with the server 104 via the network 103. The terminal devices 101 and 102 may have various applications installed thereon, such as map-like applications, voice interaction applications, webpage browser applications, communication-type applications, etc.

The terminal devices 101 and 102 may be various electronic devices capable of supporting and displaying a map-like application, and include but not limited to smart phones, tablet computers, smart wearable devices etc. The apparatus according to the present disclosure may be disposed or run in the server 104. The apparatus may be implemented as a plurality of software or software modules (e.g., for providing distributed service) or as a single software or software module, which will not be limited in detail herein.

For example, the apparatus for retrieving geographic positions is disposed and runs in the server 104, and the server 104 may receive a retrieval request of the terminal device 101 or 102, the retrieval request including a query. The apparatus for retrieving geographic positions retrieves the geographic position in a manner provided by embodiments of the present disclosure, and returns a retrieval result to the terminal device 101 or 102. A map database is maintained at the server 104 end. The map database may be locally stored in the server 104 or stored in other servers for invocation by the server 104. The server 104 can also acquire and record the user's behaviors related to use of the map-like applications, thereby forming a historical click log, a historical browse log etc.

The server 104 may be a single server or a server group consisting of a plurality of servers. It should be appreciated that the number of the terminal devices, network and server in FIG. 1 is only for illustration purpose. Any number of terminal devices, networks and servers are feasible according to the needs in implementations.

The core idea of the present disclosure lies in using an international character vector representation dictionary to map characters of different languages to the same vector space, obtaining a vector representation of the query and a vector representation of a geographic position, respectively, based on the vector representations of the characters, thereby determining the retrieved geographic position further based on the vector representation of the query and the vector representation of the geographic position. The method and apparatus according to the present disclosure will be described in detail in conjunction with embodiments.

### Embodiment 1

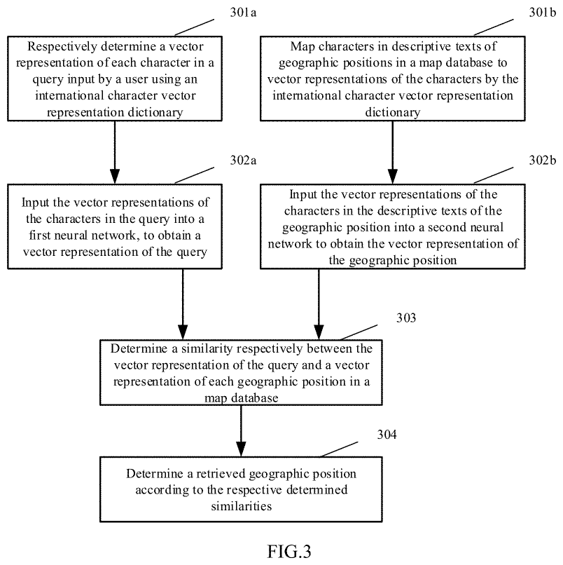

The method for retrieving geographic positions implemented in the present application is based on a similarity model. As shown in FIG. 2, the similarity model may include an international character vector representation dictionary (“Dictionary” in short in the figure), a first neural network and a second neural network. The method for retrieving geographic positions may include the following steps as shown in FIG. 3:

At 301a, after a query input by the user is obtained, a vector representation of each character in the query input by the user is respectively determined using the international character vector representation dictionary. Take the query “KFC” input by the user as an example, a character vector representation of “K”, a character vector representation of “F” and a character vector representation of “C” are determined respectively using the international character vector representation dictionary.

The international character vector representation dictionary involved in the present application is used to map characters of at least two languages to the same vector space so that a vector representation can be obtained from quantization when characters of the different languages are quantized. The vector representations obtained by mapping the characters of all languages have the same dimensionality.

Assuming c is a character which may be a character of any language supported by the dictionary and C is the vector representation corresponding to c, C is expressed as follows:

C=D(c)

where D( ) is a mapping function employed by the international character vector representation dictionary.

Likewise, at 301b, characters in descriptive texts of geographic positions in a map database may also be mapped by the international character vector representation dictionary to vector representations of the characters. The geographic positions involved in the present application include geographic positions in the map database and refer to geographic position points in the map-like applications. The geographic position points may be provided for searching and browsing by the user and recommended to the user. These geographic position points have basic attributes such as latitude and longitude, names, administrative address and types. The geographic position points may include but not limited to POI (Point of Interest), AOI (Area of Interest) and ROI (Region of Interest) etc.

To enable implementation, during retrieval, that the geographic position is not only made matching with the query in terminology, descriptive information of other geographic positions can also be retrieved matching with the query, in the present disclosure, after vector representations are determined respectively for the characters in the descriptive texts of geographic positions, vector representations of the geographic positions are further determined. The descriptive texts may include but not limited to at least one type of name, tag, address, comment and picture descriptive text. The information of these descriptive texts is also stored and maintained in the map data.

For example, as far as the geographic position “KFC (store at Xizhimen South Street)”, the descriptive texts include:

Name-“KFC (store at Xizhimen South Street)”,

Address-“Floor #2, No. A-15-6, Xizhimen South Street, Xicheng District, Beijing”,

Tag-“chain store”, “convenient transport”, “on-job meal”, “Western style snack food, etc.,

Comment—“delicious”, “popular”, “suitable for parents and kids”, etc.

. . .

The characters in the above descriptive texts may be mapped by the international character vector representation dictionary to vector representations of the characters.

At 302a, the vector representations of respective characters of the query are input into the first neural network to obtain a vector representation of the query as output. At 302b, the vector representations of the characters in the descriptive texts of the geographic position are input into the second neural network to obtain the vector representation of the geographic position. As such, the vector representations of the geographic positions in the map database may be obtained respectively.

In the present disclosure, the types of the first neural network and second neural network are not limited, as long as the dimensions of vectors output by the two neural networks are kept consistent. For example, the two neural networks may employ CNN (Convolutional Neural Networks), and ERNIE (Enhanced Representation through kNowledge IntEgration). Additionally, it needs to be appreciated that the “first” and “second” etc. involved in embodiments of the present disclosure are only intended to distinguish terms and not to limit meanings such as order, number and degree of importance.

It is assumed that the query consists of a series of m characters q₁, q₂, . . . , qₘ, and the descriptive text of a certain geographic position consists of n characters, namely, p₁, p₂, . . . , pₙ. After the vector representations corresponding characters are obtained, vectors y and z having the same dimensions are respectively obtained through a neural network (assuming that G( ) is a neural network corresponding to the query, and H( ) is a neural network corresponding to the geographic position):

G(q₁,q₂, . . . ,qₘ)=y

H(p₁,p₂, . . . ,pₙ)=z

In addition, the vector representations of the geographic positions in the map database may be determined in real time during retrieval. However, preferably, it is possible to directly invoke a result during the retrieval after the vector representations are determined in advance, i.e., 301b and 302b are processes already performed offline in advance.

At 303, a similarity respectively between the vector representation of the query and a vector representation of each geographic position in the map database is determined. The similarity s between the vectors y and z may be quantized by using for example cosine similarity:

$$s = S ( {q}_{1} , {q}_{2} , … , {q}_{m} ; {p}_{1} , {p}_{2} , … , {p}_{n} ) = cosine ( y , z )$$

At 304, the retrieved geographic position is determined based on the respective determined similarities. The similarity may be independently taken as a basis for ranking the geographic positions, or a non-independent manner may be employed, i.e., the similarity, as one of feature vectors, may be integrated into a conventional ranking model.

When the similarity is independently taken as the basis for ranking the geographic positions, the geographic positions may be ranked in a descending order of similarity, and the retrieved geographic position may be determined according to the ranking result. For example, top N geographic positions are selected as the retrieved geographic positions, N being a preset positive integer. Again for example, geographic positions with similarity exceeding a preset similarity threshold are selected as the retrieved geographic positions. As another example, the geographic positions are displayed in a descending order of the similarity, and the number of displayed geographic positions is determined according to the user's operation (e.g., a page can display five geographic positions, and next five geographic positions will be displayed if the user has an operation of pulling down to refresh).

When the non-independent manner is employed, a similarity feature may be determined using the similarity, the similarity feature may be taken as one of input vectors of a ranking model obtained by pre-training, and the retrieved geographic positions may be determined using the ranking model's ranking result of the geographic positions.

The following retrieval demands may be satisfied by the implementation method stated in the Embodiment 1.

Retrieval Demand 1:

The user inputs the query “Eiffel Tower”. Since the international character vector representation dictionary is used to map the characters in the query and characters in the descriptive text of the geographic position to the same vector space, even though the descriptive text employs the French name “La Tour Eiffel” or English name “Eiffel Tower”, it can also be at very close distance in the same vector space, thereby realizing the cross-language geographic position retrieval demand.

Retrieval Demand 2:

The user inputs the query “KFC”. After the characters in the query and characters in the descriptive text of the geographic position are all mapped to the same vector space, the vector representation of the query and the vector representation of the geographic position are obtained using the vector representations of the characters. Even though the descriptive text employs the full name “Kentucky Fried Chicken”, it can also be at very close distance in the same vector space, thereby realizing the semantics-based geographic position retrieval demand.

The similarity model needs to be trained in advance to implement the above Embodiment 1. The training process of the similarity model will be described in detail in conjunction with Embodiment 2 and Embodiment 3, respectively.

### Embodiment 2

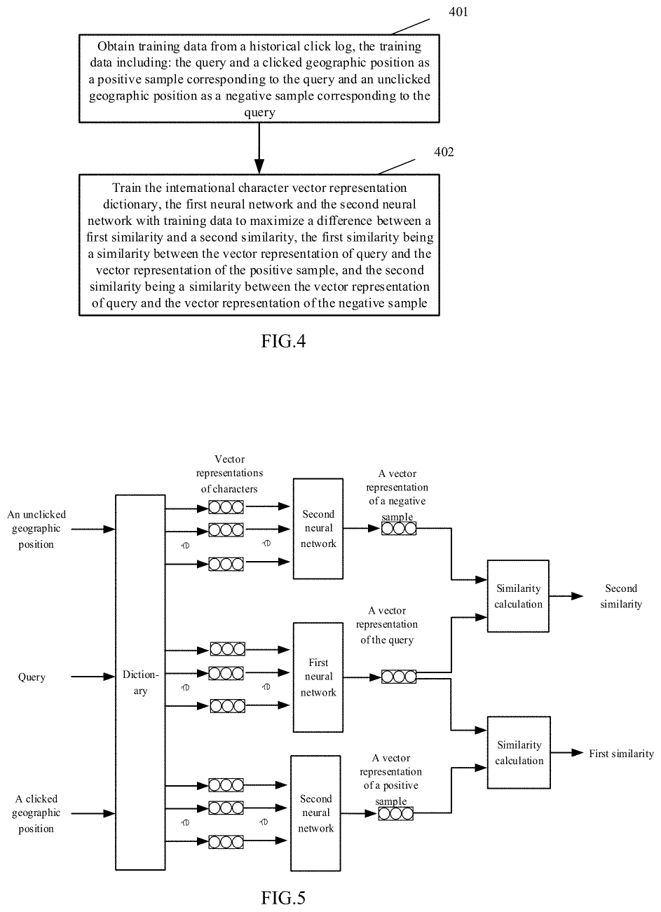

In the present embodiment, the historical click log is used to implement the training of the similarity model. The historical click log is a log regarding whether the user clicks the retrieved geographic position, generated based on a retrieval historical record. A process of training the similarity model according to the present embodiment may include the following steps as shown in FIG. 4:

At 401, training data is obtained from the historical click log, the training data including: the query and a clicked geographic position as a positive sample corresponding to the query and an unclicked geographic position as a negative sample corresponding to the query.

When the training data is obtained in the step, each piece of training data actually includes a sample pair including a positive sample and a negative sample. Regarding the same query, a clicked geographic position is selected from the retrieval result corresponding to the query as the positive sample, and then a geographic position is selected from the unclicked geographic positions as the negative sample.

For example, it is assumed that in the historical click log, the retrieval result corresponding to the query “KFC” includes the following geographic positions: KFC (Xizhimen Store), KFC (Huilongguan Store), KFC (Sanyuanqiao Store), etc. If the user clicks “KFC (Huilongguan Store)” and does not click geographic positions, one piece of training data may include: “KFC”−“KFC (Huilongguan Store)” as the positive sample pair, and “KFC”-KFC (Sanyuanqiao Store)” as the negative sample pair.

Many pieces of training data may be selected in this way.

At 402, the international character vector representation dictionary, the first neural network and the second neural network are trained with the training data to maximize a difference between a first similarity and a second similarity, wherein the first similarity is a similarity between the vector representation of the query and the vector representation of the positive sample, and the second similarity is a similarity between the vector representation of the query and the vector representation of the negative sample.

Specifically, it is possible to, as shown in FIG. 5, first use the international character vector representation dictionary (“Dictionary” in short in the figure) to respectively determine the vector representations of the characters in the training data, i.e., retrieve the vector representations of the characters in the query, the vector representations of the characters in the descriptive text of the clicked geographic position as the positive sample, and the vector representations of the characters in the descriptive text of the unclicked geographic position as the negative sample.

All characters herein, in whatever language, can be mapped by the international character vector representation dictionary to the same vector space. The vector representations of all characters all have the same dimensions.

Then, the vector representations of the characters in the query are input into the first neural network to obtain the vector representation of the query; the vector representations of the characters in the descriptive text of the geographic position as the positive sample and the vector representations of the characters in the descriptive text of the geographic position as the negative sample are respectively input into the second neural network, to obtain the vector representation of the positive sample and the vector representation of the negative sample. In the present disclosure, the types of the first neural network and second neural network are not limited, so long as the dimensions of vectors output by the two neural networks are kept consistent. For example, the two neural networks may employ CNN (Convolutional Neural Networks), and ERNIE (Enhanced Representation through kNowledge IntEgration).

Then, the first similarity between the vector representation of the query and the vector representation of the positive sample, and the second similarity between the vector representation of the same query and the vector representation of the negative sample are determined.

The international character vector representation dictionary, the first neural network and the second neural network may be trained with the first similarity and the second similarity to maximize the difference between the first similarity and the second similarity.

That is to say, a training target is to maximize the first similarity and minimize the second similarity to maximize the difference between the first similarity and the second similarity.

The training target may be represented as minimizing a loss function. The loss function Loss may employ for example:

Loss=max[0,γ+cosine(y,z⁺)−cosine(y,z⁻)]

where y is the vector representation of the query, z⁺ is the vector representation of the positive sample, z⁻ is the vector representation of the negative sample, and γ is a hyperparameter.

During training, the value of Loss is used to iteratively update the model parameters, including parameters of the international character vector representation dictionary, the first neural network and the second neural network until the training target is achieved. For example, the value of Loss satisfies a preset requirement, the iteration times satisfy a preset requirement, etc.

The model training method according to the present embodiment may breaks through the limitation of literal matching in geographic position retrieval to achieve the following retrieval demands:

For example, some geographic positions have joking names, short names or nicknames popular among users. If these names cannot be collected instantly and directed to a synonym dictionary, it is very difficult to achieve the geographic position retrieval actually needed by the user. For example, regarding KFC, many users jokingly call it “Kaifeng-style dish”. With the manner provided by the present disclosure, when the users input the query “Kaifeng-style dish”, if some users or more and more users click “KFC”-related geographic positions in the retrieval results of the geographic positions, similarity association between “KFC” and “Kaifeng-style dish” can be established during the above training process, so that during actual retrieval, when a user inputs the query “Kaifeng-style dish”, the KFC-related geographic positions can be retrieved.

However, the similarity model obtained by training in the present embodiment is usually very dependent on existing queries and geographic positions having clicking history. Regarding frequently-appearing and clicked queries and geographic positions, the model has an excellent effect in the ranking of the retrieval results. However, regarding those sparsely-appearing queries and geographic positions, even queries and geographic positions that never appear, the model provides very undesirable retrieval results, i.e., fails to solve the problem of cold start of sparse historical click log. To solve the technical problem, the present disclosure further provides a preferred model training method, which will be described below in detail through Embodiment 3.

### Embodiment 3

In order to enable the geographic positions with sparse click times, even never-clicked geographic positions (e.g., newly-appearing geographic positions) to gain a good retrieval ranking result, association between the existing geographic positions with a high click frequency and geographic positions with a low click frequency or never clicked is established from another perspective in the present embodiment. Therefore, in addition to the historical click log, a historical browse log is introduced in the training process of the model. The association between geographic positions is established through a browse co-occurrence relationship.

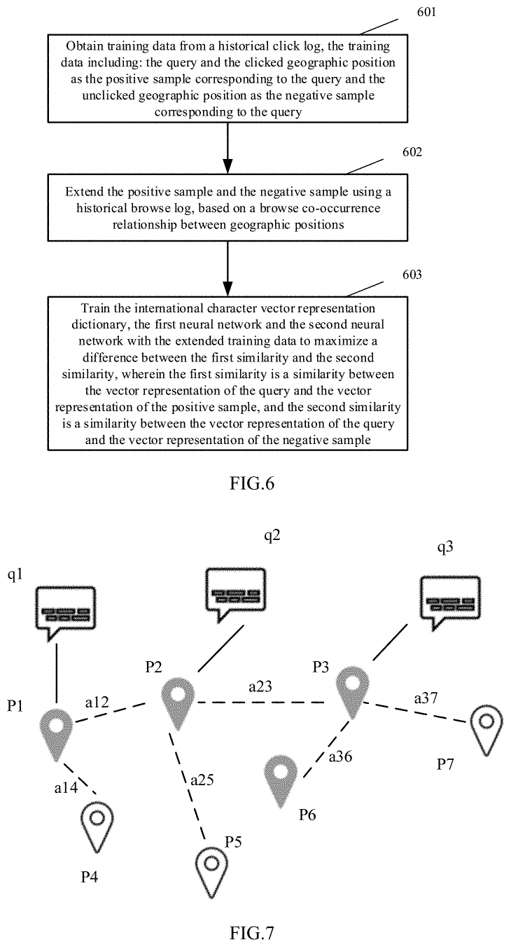

FIG. 6 illustrates a flow chart of a method for training a similarity model according to Embodiment 3 of the present disclosure. As shown in FIG. 6, the method may include the following steps:

At 601, training data is obtained from a historical click log, the training data including: the query and a clicked geographic position as a positive sample corresponding to the query and an unclicked geographic position as a negative sample corresponding to the query.

The step is identical with 401 in Embodiment 2 and will not be detailed any more here.

At 602, the positive sample and negative sample are extended using a historical browse log, based on a browse co-occurrence relationship between geographic positions.

In addition to the historical click log, the historical browse log is also introduced into the present disclosure. The historical browse log is obtained by the user by recording browsing behaviors of the geographic positions, and includes but not limited to: the user's browsing behaviors during the retrieval, random browsing behaviors upon looking up geographic positions in the map application, browsing behaviors performed through the information recommendation of the map application, etc.

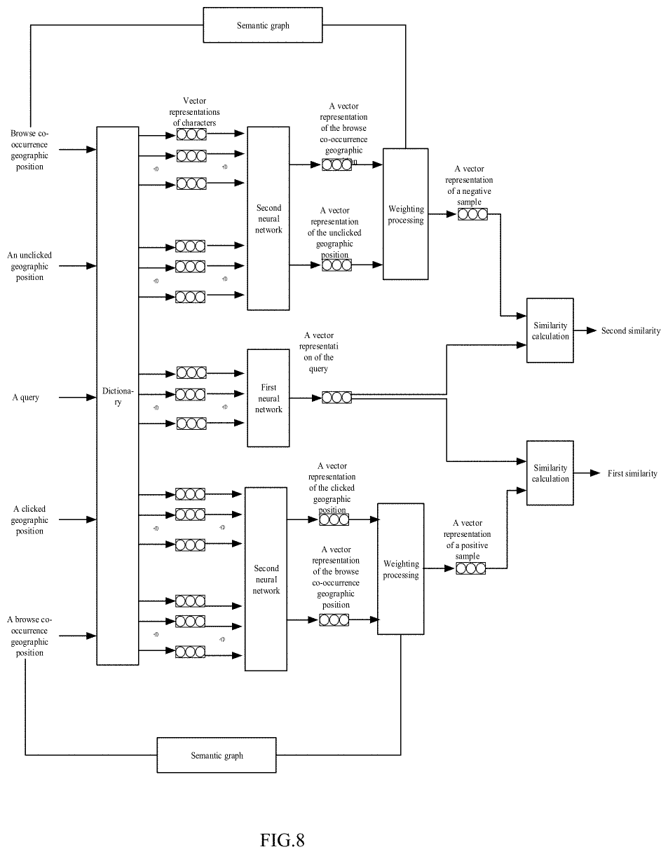

FIG. 7 is taken as an example for illustration to provide more intuitive understanding. In FIG. 7, regarding the queries “q1”, “q2” and “q3”, there is a clicked geographic position P1 corresponding to q1, a clicked geographic position P2 corresponding to q2 and a clicked geographic position P3 corresponding to q3 in the historical click log. The click-based association is shown in a solid line in FIG. 7. However, it can be obtained based on the historical browse log that the user also browses P2 and P4 while browsing P1. It may be believed that P1 and P2 are in the browse co-occurrence relationship, and P1 and P3 are in the browse co-occurrence relationship. If a plurality of geographic positions are sequentially browsed in one session, it is believed that the plurality of geographic positions are in the co-occurrence relationship.

In FIG. 7, the association between geographic positions based on the browse co-occurrence relationship is represented with a dotted line. A sematic graph may be built using the association between the geographic positions based on the historical browse log to facilitate extending the samples. In the sematic graph, nodes are geographic positions, the association between geographic positions indicates that there is the browse co-occurrence relationship between the geographic positions, and association parameters also exist between the geographic positions. “a12” marked in FIG. 7 is an association parameter between P1 and P2, “a14” is an association parameter between P1 and P4, and “a23” is an association parameter between P2 and P3, and so on so forth. The association parameters reflect the browse co-occurrence relationship between the geographic positions, and may be initially determined based on the co-occurrence situations between corresponding geographic positions, e.g., determined based on the number of co-occurrence times. The larger the number of co-occurrence times is, the larger the corresponding association parameter value is. The association parameter value will also play a role in subsequent training process. For particulars, please refer to the depictions regarding step 603.

In this step, it is possible to respectively obtain, from the sematic graph, geographic positions in the browse co-occurrence relationship with the clicked geographic position to extend the positive sample, and obtain geographic positions in the browse co-occurrence relationship with the unclicked geographic position to extend the negative sample. The manner of extending the positive sample and negative sample using the semantic graph may directly look up the sematic graph for the browse co-occurrence relationship between geographic positions, and is more convenient and more efficient.

For example, regarding a piece of training data, q1-P1 is a positive sample pair, and q1-P7 is a negative sample pair. After extension, P1, P2 and P4 may be extended to constitute the geographic positions in the positive sample, and P7 and P3 may be extended to constitute geographic positions in the negative sample.

At 603, the international character vector representation dictionary, the first neural network and the second neural network are trained with the extended training data to maximize a difference between a first similarity and a second similarity, wherein the first similarity is a similarity between the vector representation of the query and the vector representation of the positive sample, and the second similarity is a similarity between the vector representation of the query and the vector representation of the negative sample.

Specifically, it is possible to, as shown in FIG. 8, first use the international character vector representation dictionary to respectively determine the vector representations of the characters in the training data, i.e., retrieve the vector representations of the characters in the query, the vector representations of the characters in the descriptive texts of the clicked geographic position as the positive sample and geographic positions in the browse co-occurrence relationship with the clicked geographic position, and the vector representations of the characters in the descriptive texts of the unclicked geographic position as the negative sample and geographic positions in the browse co-occurrence relationship with the unclicked geographic position.

All characters herein, in whatever language, can be mapped by the international character vector representation dictionary to the same vector space. The vector representations of all characters all have the same dimensions.

Then, the vector representations of the characters in the query are input into the first neural network to obtain the vector representation of the query.

The vector representations of the characters in the description text of the clicked geographic position are input into the second neural network to obtain the vector representation of the unclicked geographic position, and the vector representations of characters in the descriptive texts of geographic positions (called browse co-occurrence geographic positions in the figure) in the browse co-occurrence relationship with the clicked geographic position are respectively input into the second neural network to obtain the vector representations corresponding to the browse co-occurrence geographic positions. Weighting processing is performed on the vector representations of the geographic positions output by the second neural network according to the association parameters between corresponding geographic positions in the semantic graph, to obtain the vector representation of the positive sample.

The semantic graph shown in FIG. 7 is still taken as an example. The positive-sample geographic positions corresponding to q1 includes P1, P2 and P4. After obtaining the vector representation V1 of P1, vector representation V2 of P2 and vector representation V4 of P4, respectively, the second neural network may perform the following weighting processing to obtain the vector representation z⁺ of the positive sample:

z⁺=V1+a12*V2+a14*V4.

The vector representations of the characters in the descriptive text of the unclicked geographic position, and vector representations of the characters in the descriptive texts of geographic positions in the browse co-occurrence relationship with the unclicked geographic position are respectively input into the second neural network, and weighing processing is performed on the vector representations of geographic positions output by the second neural network according to the association parameters between corresponding geographic positions in the semantic graph, to obtain the vector representation of the negative sample.

Continuing with the above example, negative-sample geographic positions corresponding to q1 include P7 and P3, and the second neural network respectively obtain the vector representation V7 of P7, and vector representation V3 of P3. Weighting processing is performed according to the semantic graph shown in FIG. 7 to obtain the vector representation z⁻ of the negative sample.

z⁻=V7+a37*V3

Then, determination is made as to the first similarity between the vector representation of the query and the vector representation of the positive sample, and the second similarity between the vector representation of the same query and the vector representation of the negative sample.

The international character vector representation dictionary, the first neural network and the second neural network may be trained with the first similarity and the second similarity to maximize the difference between the first similarity and the second similarity.

That is to say, a training target is to maximize the first similarity and minimize the second similarity to maximize the difference between the first similarity and the second similarity.

The training target may be represented as minimizing a loss function. The loss function Loss may employ for example:

Loss=max[0,γ+cosine(y,z⁺)−cosine(y,z⁻)]

where y is the vector representation of the query, z⁺ is the vector representation of the positive sample, z⁻ is the vector representation of the negative sample, and γ is a hyperparameter.

During training, the value of Loss is used to iteratively update the model parameters, including parameters of the international character vector representation dictionary, the first neural network and the second neural network until the training target is achieved. For example, the value of Loss satisfies a preset requirement, the iteration times satisfy a preset requirement, etc.

The association parameters in the semantic graph will also be updated during training, so that the association relationship between the geographic positions based on the browse co-occurrence is gradually optimized to achieve the training target.

The model training method according to the present embodiment may solve the problem of the cold start of geographic position retrieval corresponding to the coefficient of click times, and already meet for example the following retrieval demands:

Regarding some newly-appearing geographic positions, for example, “KFC (Huilongguan Store) is a newly-opened store, since initially it does not appear in the historical click log or the number of click times is very small, it is very difficult to obtain the new geographic position by retrieving through the model built in Embodiment 2. However, in the model building manner of Embodiment 3, during use of the map by browsing the map, he simultaneously browses the geographic position “KFC (Xizhimen Store” that has already appear very long in a session and meanwhile browses “KFC (Huilongguan Store)”, or browses “KFC (Xizhimen Store)” and “KFC (Huilongguan Store)” simultaneously in the information recommending function of the map application. Then, the association between the geographic position “KFC (Xizhimen Store)” and “KFC (Huilongguan Store)” is established in the semantic graph. Since “KFC (Xizhimen Store)” is a geographic position that has already appeared very long and has been clicked many times in history, during the establishment of the similarity model and during the training of “KFC (Xizhimen Store)” as the positive sample, “KFC (Huilongguan Store)” also does contribution to the vector of the positive sample such that “KFC (Huilongguan Store)” also establish an association with the query “KFC” of “KFC (Xizhimen Store)”. In this case, when the user retrieve “KFC”, he can also find “KFC (Huilongguan Store)” in the retrieval result based on the similarity, thereby solving the problem of cold start of “KFC (Huilongguan Store)”.

The method according to the present disclosure is described in detail above. An apparatus according to the present disclosure will be described below in detail in conjunction with embodiments.

### Embodiment 4

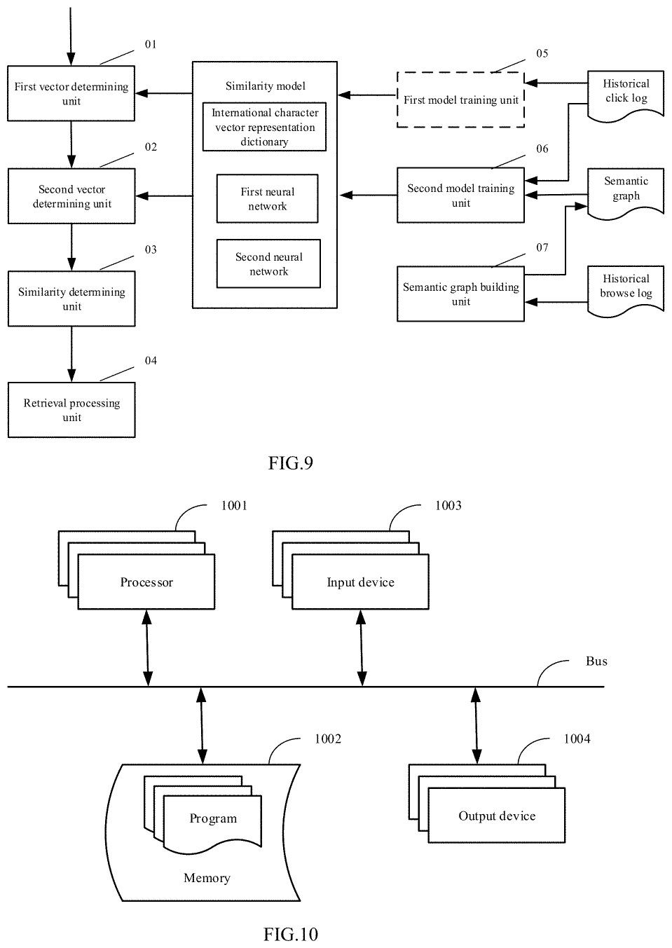

FIG. 9 illustrates a block diagram of an apparatus for retrieving geographic positions according to embodiments of the present disclosure. The apparatus may be an application located at the server end, or a function unit such as a plug-in or a Software Development Kit (SDK) of the application located at the server end, which will not specifically be limited in this regard. As shown in FIG. 9, the apparatus may include: a first vector determining unit 01, a second vector determining unit 02, a similarity determining unit 03 and a retrieval processing unit 04, and may further include: a first model training unit 05 or a second model training unit 06. Main functions of the units are as follows: The first vector determining unit 01 is configured to respectively determine a vector representation of each character in a query input by a user using an international character vector representation dictionary, the international character vector representation dictionary being used to map characters of at least two languages to the same vector space.

The second vector determining unit 02 is configured to input vector representations of respective characters in the query into a first neural network obtained by pre-training, to obtain a vector representation of the query.

The similarity determining unit 03 is configured to determine a similarity respectively between the vector representation of the query and a vector representation of each geographic position in a map database.

The vector representation of each geographic position is obtained by using the first vector determining unit 01 to use the international character vector representation dictionary to determine vector representations of characters in descriptive texts of the geographic positions, and then using the second vector determining unit 02 to input the vector representations of the characters in the descriptive texts of the geographic positions into a second neural network obtained by pre-training. The vector representations of the geographic positions may be determined in real time during retrieval of the geographic positions. However, as a preferred embodiment, the vector representations of the geographic positions may be obtained in an offline manner, and then the similarity determining unit 03 invokes, in real time, the vector representations of geographic positions in the map data obtained offline during retrieval.

The descriptive texts of geographic positions may include at least one type of name, tag, address, comment and picture descriptive text.

The retrieval processing unit 04 is configured to determine a retrieved geographic position according to respective similarities.

Specifically, the retrieval processing unit 04 may rank the geographic positions in a descending order of similarity, and determine the retrieved geographic position according to a ranking result.

Alternatively, the retrieval processing unit 04 may determine a similarity feature using the similarity, take the similarity feature as one of input vectors of a ranking model obtained by pre-training, and determine the retrieved geographic position using the ranking result of the geographic positions by the ranking model.

The first model training unit 05 and the second model training unit 06 are configured to pre-train the similarity model consisting of the international character vector representation dictionary, the first neural network and the second neural network. One of the first model training unit 05 and the second model training unit 06 may be employed in the present disclosure.

The first model training unit 05 is configured to perform the following training process in advance:

obtaining training data from a historical click log, the training data including: the query and a clicked geographic position as a positive sample corresponding to the query and an unclicked geographic position as a negative sample corresponding to the query;

training the international character vector representation dictionary, the first neural network and the second neural network with the training data to maximize a difference between a first similarity and a second similarity, wherein the first similarity is a similarity between the vector representation of the query and the vector representation of the positive sample, and the second similarity is a similarity between the vector representation of the query and the vector representation of the negative sample.

Specifically, when training the international character vector representation dictionary, the first neural network and the second neural network with the training data, the first model training unit 05 may perform:

using the international character vector representation dictionary to respectively determine the vector representations of the characters in the training data;

inputting the vector representations of the characters in the query into the first neural network to obtain the vector representation of the query; inputting the vector representations of the characters in the descriptive text of the geographic position as the positive sample and the vector representations of the characters in the descriptive text of the geographic position as the negative sample respectively into the second neural network, to obtain the vector representation of the positive sample and the vector representation of the negative sample.

determining the first similarity between the vector representation of the query and the vector representation of the positive sample, and the second similarity between the vector representation of the same query and the vector representation of the negative sample;

training the international character vector representation dictionary, the first neural network and the second neural network to maximize a difference between the first similarity and the second similarity.

The second model training unit 06 is configured to perform the following training process in advance:

obtaining training data from the historical click log, the training data including: the query and the clicked geographic position as the positive sample corresponding to the query and the unclicked geographic position as the negative sample corresponding to the query;

extending the positive sample and negative sample using a historical browse log, based on a browse co-occurrence relationship between geographic positions;

training the international character vector representation dictionary, the first neural network and the second neural network with the extended training data to maximize a difference between the first similarity and the second similarity, wherein the first similarity is a similarity between the vector representation of the query and the vector representation of the positive sample, and the second similarity is a similarity between the vector representation of the query and the vector representation of the negative sample.

Specifically, the second model training unit 06 may respectively obtain, from the sematic graph, first geographic positions in the browse co-occurrence relationship with the clicked geographic position to extend the positive sample, and obtain second geographic positions in the browse co-occurrence relationship with the unclicked geographic position to extend the negative sample.

When training the international character vector representation dictionary, the first neural network and the second neural network with the extended training data, the second model training unit 06 may specifically perform the following:

using the international character vector representation dictionary to respectively determine the vector representations of the characters in the training data;

inputting the vector representations of the characters in the query into the first neural network to obtain the vector representation of the query; inputting the vector representations of the characters in the description text of the clicked geographic position and vector representations of the characters in the descriptive texts of the first geographic positions respectively into the second neural network, and performing weighting processing on the vector representations of the geographic positions output by the second neural network according to association parameters between corresponding geographic positions in the semantic graph, to obtain the vector representation of the positive sample; inputting the vector representations of the characters in the description texts of the unclicked geographic position and vector representations of the characters in the descriptive texts of the second geographic positions respectively into the second neural network, and performing weighting processing on the vector representations of the geographic positions output by the second neural network according to association parameters between corresponding geographic positions in the semantic graph, to obtain the vector representation of the negative sample;

determining the first similarity between the vector representation of the query and the vector representation of the positive sample, and the second similarity between the vector representation of the same query and the vector representation of the negative sample;

training the international character vector representation dictionary, the sematic graph, the first neural network and the second neural network to maximize a difference between the first similarity and the second similarity.

In the case where the second model training unit 06 is employed, the apparatus further comprises:

a sematic graph building unit 07 configured to build a sematic graph based on a historical browse log, nodes in the sematic graph being geographic positions, association between corresponding nodes being established for geographic positions in the browse co-occurrence relationship, association parameters between the geographic positions being initially determined according to co-occurrence situations between the geographic positions.

Correspondingly, the second model training unit 06 updates the association parameters between geographic positions in the sematic graph during training.

In addition to obtaining the training data from the historical click log, the second model training unit 06 further obtains the training data from the historical browse log, and extends the positive sample and negative sample in the training data based on the browse co-occurrence relationship, thereby solving the problem of the cold start of geographic position retrieval corresponding to the coefficient of click times. Therefore, the second model training unit 06 is preferably employed in the present disclosure. Therefore, the first model training unit 05 is represented in a dotted line in FIG. 9.

According to embodiments of the present disclosure, the present disclosure further provides an electronic device and a readable storage medium.

As shown in FIG. 10, it shows a block diagram of an electronic device for implementing the method for retrieving geographic positions according to embodiments of the present disclosure. The electronic device is intended to represent various forms of digital computers, such as laptops, desktops, workstations, personal digital assistants, servers, blade servers, mainframes, and other appropriate computers. The electronic device is further intended to represent various forms of mobile devices, such as personal digital assistants, cellular telephones, smartphones, wearable devices and other similar computing devices. The components shown here, their connections and relationships, and their functions, are meant to be exemplary only, and are not meant to limit implementations of the inventions described and/or claimed in the text here.

As shown in FIG. 10, the electronic device comprises: one or more processors 1001, a memory 1002, and interfaces configured to connect components and including a high-speed interface and a low speed interface. Each of the components are interconnected using various busses, and may be mounted on a common motherboard or in other manners as appropriate. The processor can process instructions for execution within the electronic device, including instructions stored in the memory or on the storage device to display graphical information for a GUI on an external input/output device, such as a display device coupled to the interface. In other implementations, multiple processors and/or multiple buses may be used, as appropriate, along with multiple memories and types of memory. Also, multiple electronic devices may be connected, with each device providing portions of the necessary operations (e.g., as a server bank, a group of blade servers, or a multi-processor system). One processor 1001 is taken as an example in FIG. 10.

The memory 1002 is a non-transitory computer-readable storage medium provided by the present disclosure. The memory stores instructions executable by at least one processor, so that the at least one processor executes the method for retrieving geographic positions according to the present disclosure. The non-transitory computer-readable storage medium of the present disclosure stores computer instructions, which are used to cause a computer to execute the method for retrieving geographic positions according to the present disclosure.

The memory 1002 is a non-transitory computer-readable storage medium and can be used to store non-transitory software programs, non-transitory computer executable programs and modules, such as program instructions/modules corresponding to the method for retrieving geographic positions in embodiments of the present disclosure. The processor 1001 executes various functional applications and data processing of the server, i.e., implements the method for retrieving geographic positions in the above method embodiments, by running the non-transitory software programs, instructions and modules stored in the memory 1002.

The memory 1002 may include a storage program region and a storage data region, wherein the storage program region may store an operating system and an application program needed by at least one function; the storage data region may store data created according to the use of the electronic device. In addition, the memory 1002 may include a high-speed random access memory, and may also include a non-transitory memory, such as at least one magnetic disk storage device, a flash memory device, or other non-transitory solid-state storage device. In some embodiments, the memory 1002 may optionally include a memory remotely arranged relative to the processor 1001, and these remote memories may be connected to the electronic device through a network. Examples of the above network include, but are not limited to, the Internet, an intranet, a local area network, a mobile communication network, and combinations thereof.

The electronic device for implementing the method for retrieving geographic positions may further include an input device 1003 and an output device 1004. The processor 1001, the memory 1002, the input device 1003 and the output device 1004 may be connected through a bus or in other manners. In FIG. 10, the connection through the bus is taken as an example.

The input device 1003 may receive inputted numeric or character information and generate key signal inputs related to user settings and function control of the electronic device, and may be an input device such as a touch screen, keypad, mouse, trackpad, touchpad, pointing stick, one or more mouse buttons, trackball and joystick. The output device 1004 may include a display device, an auxiliary lighting device (e.g., an LED), a haptic feedback device (for example, a vibration motor), etc. The display device may include but not limited to a Liquid Crystal Display (LCD), a Light Emitting Diode (LED) display, and a plasma display. In some embodiments, the display device may be a touch screen.

Various implementations of the systems and techniques described here may be realized in digital electronic circuitry, integrated circuitry, specially designed ASICs (Application Specific Integrated Circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to send data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

It should be understood that the various forms of processes shown above can be used to reorder, add, or delete steps. For example, the steps described in the present disclosure can be performed in parallel, sequentially, or in different orders as long as the desired results of the technical solutions disclosed in the present disclosure can be achieved, which is not limited herein.

The foregoing specific implementations do not constitute a limitation on the protection scope of the present disclosure. It should be understood by those skilled in the art that various modifications, combinations, sub-combinations and substitutions can be made according to design requirements and other factors. Any modification, equivalent replacement and improvement made within the spirit and principle of the present disclosure shall be included in the protection scope of the present disclosure.

1. A method for retrieving geographic positions, comprising:
respectively determining a vector representation of each character in a query input by a user using an international character vector representation dictionary;
inputting the vector representations of respective characters in the query into a first neural network obtained by pre-training, to obtain a vector representation of the query;
determining a similarity respectively between the vector representation of the query and a vector representation of each geographic position in a map database;
determining a retrieved geographic position according to respective similarities;
wherein the vector representation of each geographic position is obtained by using the international character vector representation dictionary to determine vector representations of characters in descriptive texts of the geographic positions, and inputting the vector representations of the characters in the descriptive texts of the geographic positions into a second neural network obtained by pre-training; the international character vector representation dictionary is used to map characters of at least two languages to the same vector space.

2. The method according to claim 1, wherein the descriptive texts of geographic positions comprise at least one type of name, tag, address, comment and picture descriptive text.

3. The method according to claim 1, wherein the determining a retrieved geographic position according to respective similarities comprises:
ranking the geographic positions in a descending order of similarity, and determining the retrieved geographic position according to a ranking result; or
determining a similarity feature using the similarity, taking the similarity feature as one of input vectors of a ranking model obtained by pre-training, and determining the retrieved geographic position using the ranking result of the geographic positions by the ranking model.

4. The method according to claim 1, wherein the method further comprises performing the following training process in advance:
obtaining training data from a historical click log, the training data including: the query and a clicked geographic position as a positive sample corresponding to the query and an unclicked geographic position as a negative sample corresponding to the query;
training the international character vector representation dictionary, the first neural network and the second neural network with the training data to maximize a difference between a first similarity and a second similarity, the first similarity being a similarity between the vector representation of the query and a vector representation of the positive sample, and the second similarity being a similarity between the vector representation of the query and a vector representation of the negative sample.

5. The method according to claim 4, wherein the training the international character vector representation dictionary, the first neural network and the second neural network with the training data comprises:
using the international character vector representation dictionary to respectively determine vector representations of characters in the training data;
inputting the vector representations of the characters in the query into the first neural network to obtain the vector representation of the query; inputting the vector representations of the characters in the descriptive texts of the geographic position as the positive sample and the vector representations of the characters in the descriptive texts of the geographic position as the negative sample respectively into the second neural network, to obtain the vector representations of the positive sample and the vector representation of the negative sample;
determining the first similarity between the vector representation of the query and the vector representation of the positive sample, and the second similarity between the vector representation of the same query and the vector representation of the negative sample;
training the international character vector representation dictionary, the first neural network and the second neural network to maximize a difference between the first similarity and the second similarity.

6. The method according to claim 1, wherein the method further comprises performing the following training process in advance:
obtaining training data from a historical click log, the training data including: the query and the clicked geographic position as the positive sample corresponding to the query and the unclicked geographic position as the negative sample corresponding to the query;
extending the positive sample and negative sample using a historical browse log, based on a browse co-occurrence relationship between geographic positions;
training the international character vector representation dictionary, the first neural network and the second neural network with the extended training data to maximize a difference between a first similarity and a second similarity, wherein the first similarity is a similarity between the vector representation of the query and the vector representation of the positive sample, and the second similarity is a similarity between the vector representation of the query and the vector representation of the negative sample.

7. The method according to claim 6, wherein the extending the positive sample and negative sample using a historical browse log, based on a browse co-occurrence relationship between geographic positions comprises:
respectively obtaining, from a sematic graph, first geographic positions in a browse co-occurrence relationship with the clicked geographic position to extend the positive sample, and obtaining second geographic positions in the browse co-occurrence relationship with the unclicked geographic position to extend the negative sample.

8. The method according to claim 7, wherein the training the international character vector representation dictionary, the first neural network and the second neural network with the extended training data comprises:
using the international character vector representation dictionary to respectively determine vector representations of characters in the training data;
inputting the vector representations of the characters in the query into the first neural network to obtain a vector representation of the query; inputting the vector representations of the characters in the description texts of the clicked geographic position and vector representations of the characters in the descriptive texts of the first geographic positions respectively into the second neural network, and performing weighting processing on the vector representations of the geographic positions output by the second neural network according to association parameters between corresponding geographic positions in the semantic graph, to obtain the vector representation of the positive sample; inputting the vector representations of the characters in the description texts of the unclicked geographic position and vector representations of the characters in the descriptive texts of the second geographic positions respectively into the second neural network, and performing weighting processing on the vector representations of the geographic positions output by the second neural network according to association parameters between corresponding geographic positions in the semantic graph, to obtain the vector representation of the negative sample;
determining a first similarity between the vector representation of the query and the vector representation of the positive sample, and a second similarity between the vector representation of the same query and the vector representation of the negative sample;
training the international character vector representation dictionary, the sematic graph, the first neural network and the second neural network to maximize a difference between the first similarity and the second similarity.

9. The method according to claim 7, wherein the sematic graph is built based on a historical browse log;
nodes in the sematic graph are geographic positions, association between corresponding nodes is established for geographic positions in the browse co-occurrence relationship, and association parameters between the geographic positions are initially determined according to co-occurrence situations between the geographic positions and updated during training.

10. An electronic device, comprising:
at least one processor; and
a memory communicatively connected with the at least one processor;
wherein the memory stores instructions executable by the at least one processor, and the instructions are executed by the at least one processor to enable the at least one processor to perform a method for retrieving geographic positions, wherein the method comprises:
respectively determining a vector representation of each character in a query input by a user using an international character vector representation dictionary;
inputting the vector representations of respective characters in the query into a first neural network obtained by pre-training, to obtain a vector representation of the query;
determining a similarity respectively between the vector representation of the query and a vector representation of each geographic position in a map database;
determining a retrieved geographic position according to respective similarities;
wherein the vector representation of each geographic position is obtained by using the international character vector representation dictionary to determine vector representations of characters in descriptive texts of the geographic positions, and inputting the vector representations of the characters in the descriptive texts of the geographic positions into a second neural network obtained by pre-training; the international character vector representation dictionary is used to map characters of at least two languages to the same vector space.

11. The electronic device according to claim 10, wherein the descriptive texts of geographic positions comprise at least one type of name, tag, address, comment and picture descriptive text.

12. The electronic device according to claim 10, wherein the determining a retrieved geographic position according to respective similarities comprises:
ranking the geographic positions in a descending order of similarity, and determine the retrieved geographic position according to a ranking result; or
determining a similarity feature using the similarity, take the similarity feature as one of input vectors of a ranking model obtained by pre-training, and determining the retrieved geographic position using the ranking result of the geographic positions by the ranking model.

13. The electronic device according to claim 10, wherein
the method further comprises performing the following training process in advance:
obtaining training data from a historical click log, the training data including: the query and a clicked geographic position as a positive sample corresponding to the query and an unclicked geographic position as a negative sample corresponding to the query;
training the international character vector representation dictionary, the first neural network and the second neural network with the training data to maximize a difference between a first similarity and a second similarity, the first similarity being a similarity between the vector representation of the query and the vector representation of the positive sample, and the second similarity being a similarity between the vector representation of the query and the vector representation of the negative sample.

14. The electronic device according to claim 13, wherein the training the international character vector representation dictionary, the first neural network and the second neural network with the training data comprises:
using the international character vector representation dictionary to respectively determine vector representations of characters in the training data;
inputting the vector representations of the characters in the query into the first neural network to obtain the vector representation of the query; inputting the vector representations of the characters in the descriptive texts of the geographic position as the positive sample and the vector representations of the characters in the descriptive texts of the geographic position as the negative sample respectively into the second neural network, to obtain the vector representation of the positive sample and the vector representation of the negative sample;
determining the first similarity between the vector representation of the query and the vector representation of the positive sample, and the second similarity between the vector representation of the same query and the vector representation of the negative sample;
training the international character vector representation dictionary, the first neural network and the second neural network to maximize a difference between the first similarity and the second similarity.

15. The electronic device according to claim 10, wherein the method further comprises performing the following training process in advance:
obtaining training data from a historical click log, the training data including: the query and the clicked geographic position as the positive sample corresponding to the query and the unclicked geographic position as the negative sample corresponding to the query;
extending the positive sample and negative sample using a historical browse log, based on a browse co-occurrence relationship between geographic positions;
training the international character vector representation dictionary, the first neural network and the second neural network with the extended training data to maximize a difference between a first similarity and a second similarity, wherein the first similarity is a similarity between the vector representation of the query and the vector representation of the positive sample, and the second similarity is a similarity between the vector representation of the query and the vector representation of the negative sample.

16. The electronic device according to claim 15, wherein the extending the positive sample and negative sample using a historical browse log, based on a browse co-occurrence relationship between geographic positions comprises:
respectively obtaining, from a sematic graph, first geographic positions in a browse co-occurrence relationship with the clicked geographic position to extend the positive sample, and obtaining second geographic positions in the browse co-occurrence relationship with the unclicked geographic position to extend the negative sample.

17. The electronic device according to claim 16, wherein the training the international character vector representation dictionary, the first neural network and the second neural network with the extended training data comprises:
using the international character vector representation dictionary to respectively determine vector representations of characters in the training data;
inputting the vector representations of the characters in the query into the first neural network to obtain a vector representation of the query; inputting the vector representations of the characters in the description texts of the clicked geographic position and vector representations of the characters in the descriptive texts of the first geographic positions respectively into the second neural network, and performing weighting processing on the vector representations of the geographic positions output by the second neural network according to association parameters between corresponding geographic positions in the semantic graph, to obtain the vector representation of the positive sample; inputting the vector representations of the characters in the description texts of the unclicked geographic position and vector representations of the characters in the descriptive texts of the second geographic positions respectively into the second neural network, and performing weighting processing on the vector representations of the geographic positions output by the second neural network according to association parameters between corresponding geographic positions in the semantic graph, to obtain the vector representation of the negative sample;
determining a first similarity between the vector representation of the query and the vector representation of the positive sample, and a second similarity between the vector representation of the same query and the vector representation of the negative sample;
training the international character vector representation dictionary, the sematic graph, the first neural network and the second neural network to maximize a difference between the first similarity and the second similarity.

18. The electronic device according to claim 16, wherein
the sematic graph is built based on a historical browse log;
nodes in the sematic graph are geographic positions, association between corresponding nodes is established for geographic positions in the browse co-occurrence relationship, and association parameters between the geographic positions are initially determined according to co-occurrence situations between the geographic positions and updated during training.

19. (canceled)

20. A non-transitory computer readable storage medium with computer instructions stored thereon, wherein the computer instructions are used for causing a computer to perform a method for retrieving geographic positions, wherein the method comprises:
respectively determining a vector representation of each character in a query input by a user using an international character vector representation dictionary;
inputting the vector representations of respective characters in the query into a first neural network obtained by pre-training, to obtain a vector representation of the query;
determining a similarity respectively between the vector representation of the query and a vector representation of each geographic position in a map database;
determining a retrieved geographic position according to respective similarities;
wherein the vector representation of each geographic position is obtained by using the international character vector representation dictionary to determine vector representations of characters in descriptive texts of the geographic positions, and inputting the vector representations of the characters in the descriptive texts of the geographic positions into a second neural network obtained by pre-training; the international character vector representation dictionary is used to map characters of at least two languages to the same vector space.

21. The method according to claim 8, wherein:
the sematic graph is built based on a historical browse log;
nodes in the sematic graph are geographic positions, association between corresponding nodes is established for geographic positions in the browse co-occurrence relationship, and association parameters between the geographic positions are initially determined according to co-occurrence situations between the geographic positions and updated during training.
